(19) United States
(12) Patent Application Publication
(10) Pub. No.: US 2013/0292914 A1
(43) Pub. Date: Nov. 7, 2013

(54) Expandable Core Chuck

(71) Applicants: Daniel J. Pienta, Lambertville, MI (US); David M. Pienta, Lambertville, MI (US)

(72) Inventors: Daniel J. Pienta, Lambertville, MI (US); David M. Pienta, Lambertville, MI (US)

(73) Assignee: Automatic Handling, Int'l

(21) Appl. No.: 13/461,085

(22) Filed: May 1, 2012

(51) Int. Cl. B23B 31/40

(52) U.S. Cl. 279/2.19

(57) ABSTRACT

An expandable core chuck includes a housing having a plurality of slots and a plurality of expansion plates movable radially outwardly from the housing to engage the interior surface of an article to be gripped. Outward movement of the expansion plates is effected by means of a camshaft and rotation of the camshaft.

### TECHNICAL FIELD

The present invention is directed to an expandable core chuck suitable for engaging the interior surface of a cylindrical core or other article having an inwardly facing cylindrical surface.

### BACKGROUND OF THE INVENTION

Many products are manufactured from elongated sheet or stock material or wire that is shipped and stored in the form of a roll or coil. Continuous strips or webs of thin, flexible material or wire are commonly provided wound on cores to provide rolls of material. The rolls of material are subsequently unwound for production of items made from the materials. Examples of these materials are plastic film, metal foil, tissue, paper and wire.

During the manufacturing process, the cores carrying the material are commonly transported to various stations within the manufacturing facility. For instance, cores of fresh material are received and transferred to unwind stations. Cores that have material removed are transported to storage facilities, core cleaning stations, or other processing stations. Core chucks are inserted into the opposed ends of the cores thereby allowing the cores to be lifted for transport and processing without damaging the sheet material contained on the core or the core itself. Different types of product have cores which have different inner diameters. In current practice, the manufacturing plant has core chucks of a variety of diameters designed to match the inner diameter of the cores. Thus, there is a need for an universal core chuck that can be used with cores having varying inner diameters of the inwardly facing cylindrical surface of the core. While this invention is described for use with cores carrying rolls of sheet material or wire, it is not intended to be so narrowly construed as to be limited only to that specific use. The present invention can be utilized to mate with a wide variety of articles having an internal cylindrical surface.

A universal core chuck or arbor for securing the internal surface of a reel or other article may be found in U.S. Pat. No. 6,494,401. The '401 patent includes a thorough discussion of prior art attempts to solve the problems of sizing chucks to cores having different inner diameters. An arbor disclosed in that patent application has a cylindrical axially extending tube with longitudinal slots. Blades are positioned in the slots and are movable radially outwardly from the tube to a position at which their outer surfaces extend slightly beyond the outer surface of the tube. The blades have an inner surface defining axially spaced apart first cam grooves having inclined wrap surfaces. A cam member includes spaced apart cam followers that include inclined ramp surfaces aligned with the first cam grooves. The cam is reciprocal via a pneumatic actuator from a first position in which the respective blades are retracted to a second position in which the blades are extended slightly outwardly from the outer surface of the tube. The present invention improves upon this complex mechanical structure.

### SUMMARY OF THE INVENTION

The present invention provides an expanding core chuck having a housing extending along an axis with a plurality of slots, preferably four, extending substantially parallel to the longitudinal axis of the housing. A camshaft having a plurality of lobes or cams is positioned in the housing and is rotatable with respect to the axis of the housing in clockwise and counterclockwise direction upon actuation by a pneumatic actuator. Each of the cams has a cam surface which extends at varying radial distances from the axis. Cam rollers or other actuators are attached to expansion plates such that, upon rotation of the cam shaft in one direction, the cam rollers will be actuated by the varying radial distance cam surfaces to move the expansion plates from a position within the housing to a position extending outwardly from the housing and into mating contact with the inner cylindrical surface of the core and, upon rotation in the opposite direction, move the expansion plates back within the housing.

Other objects and advantages of the present invention will become apparent to those skilled in the art upon a review of the following detailed description of the preferred embodiments and the accompanying drawings.

### BRIEF DESCRIPTION OF THE DRAWINGS

FIG. 1 is a perspective view of the core chuck of the present invention with the expansion plates contracted.

FIG. 2 is a view similar to FIG. 1 showing the core chuck with the expansion plates expanded.

FIG. 3 is a view similar to FIG. 1 but with the outer shell removed for clarity.

FIG. 4 is a sectional view of the core chuck of the present invention taken along the longitudinal axis.

FIG. 4A is an enlarged of a section of FIG. 4.

FIG. 5 is a schematic view taken through line 2-2 of FIG. 4, showing the essential structure of the invention.

### DETAILED DESCRIPTION OF THE INVENTION

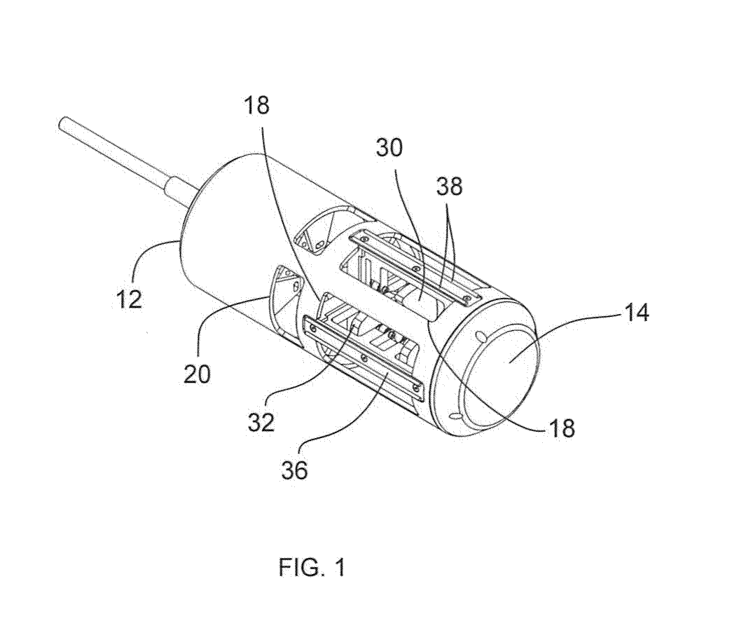

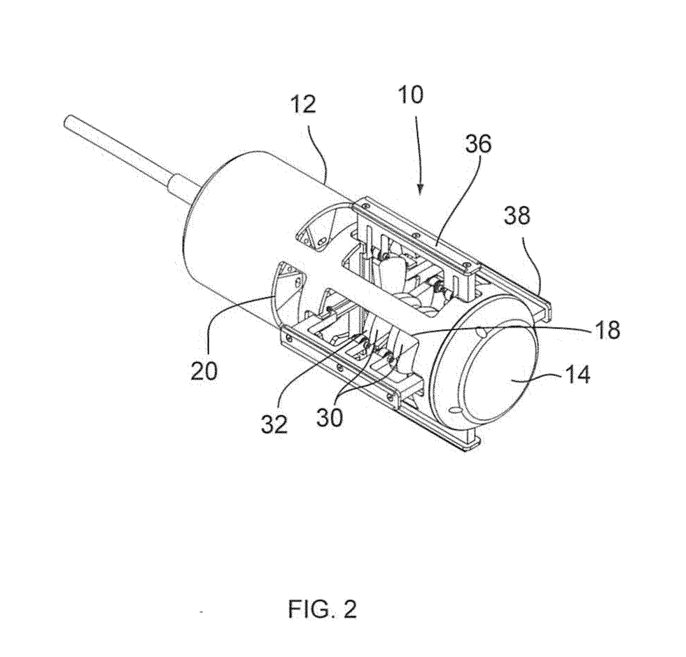

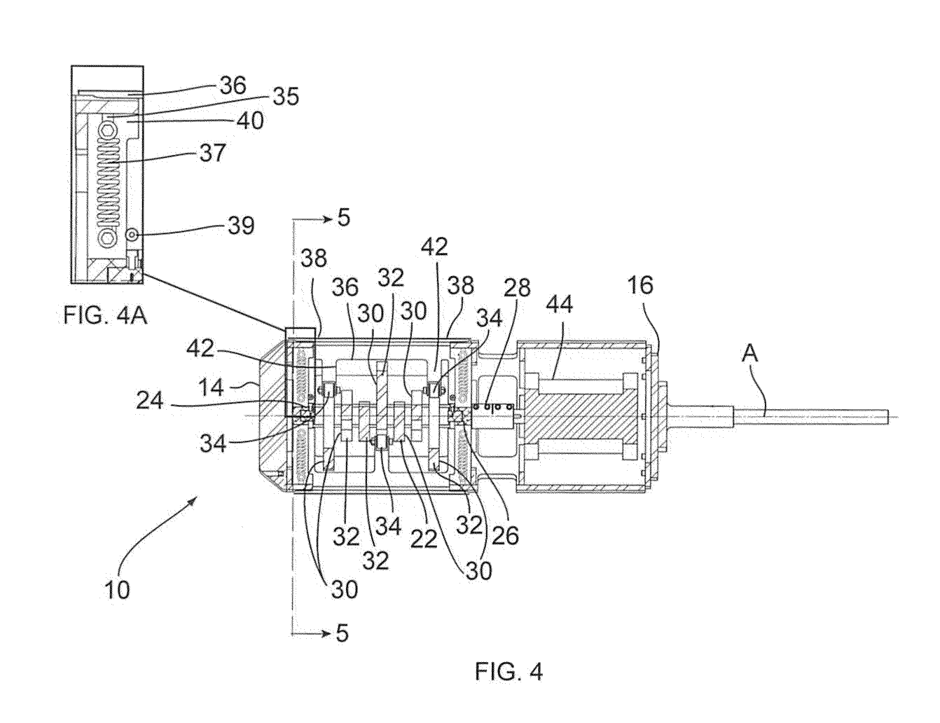

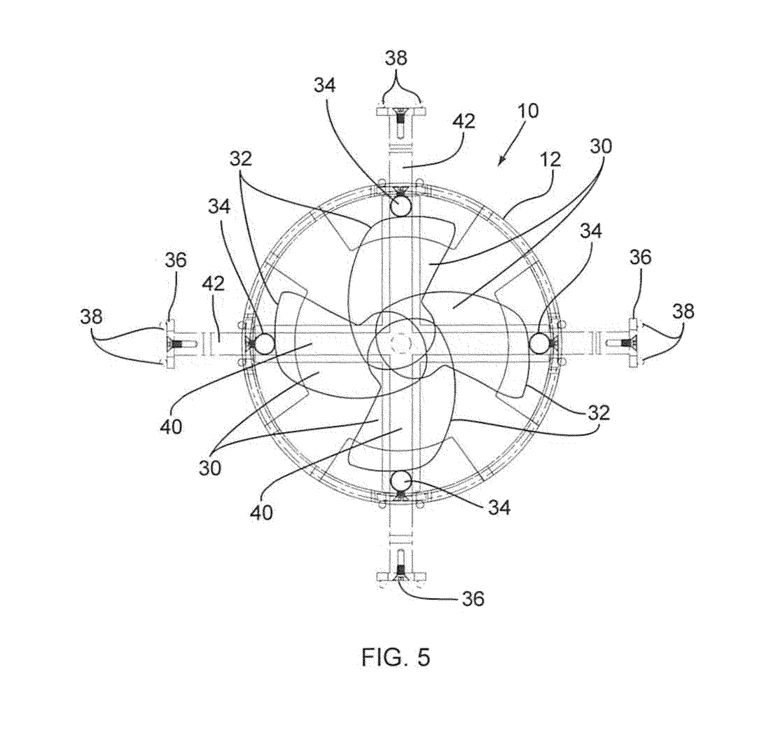

Referring to FIGS. 1 and 2 there is shown the expandable core chuck 10 of the present invention. The core chuck includes a housing or outer shell 12 extending along an axis A (FIG. 4) from a first end on which is mounted an end cap 14 to a second end on which is fastened a mounting flange 16 (FIG. 5). The outer shell has four slots 18 extending longitudinally from a point slightly spaced from the end cap 14 to approximately midway between the end cap 14 and the mounting flange 16. The outer shell 12 also has four openings 20 generally aligned with the slots 18 and spaced a short distance therefrom toward the end with the mounting flange 16. The slots 18 and the openings 20 are positioned substantially 90 degrees from adjacent slots and openings.

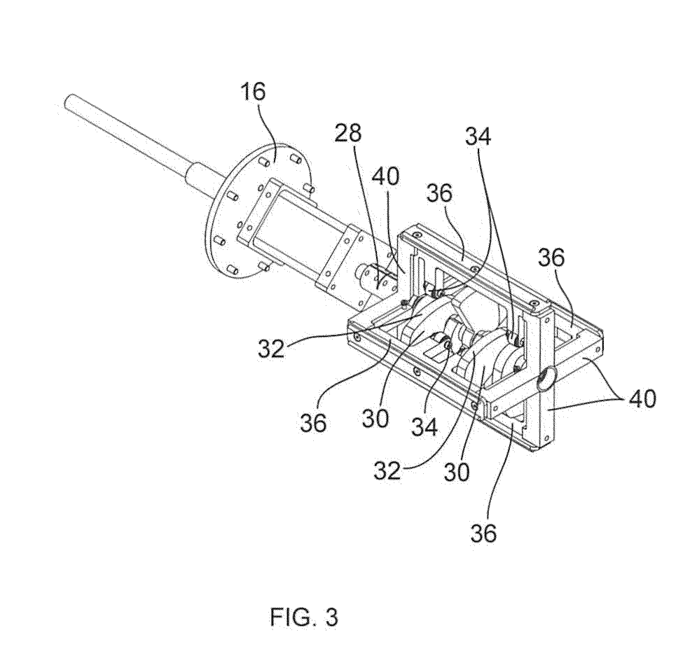

Referring to FIGS. 3, 4 and 5, housed within the shell 12 is a camshaft 22 extending along the axis A from a bearing 24 secured to the end cap 14 to a second bearing 26 fastened to a coupling 28. The coupling 28 is also secured to a pneumatic cylinder 44 which, upon actuation, rotates the coupling 28 and the camshaft 22 alternately clockwise and counterclockwise. The cam shaft 22 a plurality of cam members 30 extending radially outwardly. Each cam member 30 has a cam surface 32 which follows a path in a circumferential direction, with the path being closer to the axis A in one area and extending along a smooth gradually outwardly path to other areas progressively further from the axis A. Cam rollers 34 mounted on each of four expansion plates are engaged with each of the cam surfaces 32. Each expansion plate 36 has one or two radially extending support members 42, each of which carries the cam roller 34. Located on the outwardly facing ends of the expansion plates 36 are contact members 38 which engage the inner cylindrical surface of the cores or other articles to be cleaned.

The expansion plates 38, support member 42 and cam rollers 34 are slidably engaged with a mounting member 40 and are movable relative thereto in a radial direction from a retracted position shown in FIG. 1 to an expanded position shown in FIG. 2 in response to movement of the cam members 30 relative to the cam rollers 34. The support members 42 and expansion plates 36 are urged outwardly when the camshaft 22 is rotating in a direction in which the cam surfaces 32 push the cam rollers 34 outwardly. Rotation of the camshaft 22 in one direction will force the cam rollers 34 engaged with the cam surfaces 32 to move radially outwardly away from the axis A.

FIGS. 4 and 4A show in detail the elastic members 37 that are engaged with the mounting members 40 and the support members 42 through slots 35. As the cam surfaces 32 push the cam rollers 34 radially outwardly, the elastic members 37 are elongated. When the camshaft 22 is rotated in the opposite direction from that which moves the expansion plates 36 outwardly, the elastic members 37 pull the support members 42 and expansion plates 36 radially inward. Guides 39, located on the support members 42 are engaged with an edge of the mounting members 40 to ensure that the support members 42 and expansion plates move in a non-skewed manner.

Upon insertion of the core chuck into the end of the core, the pneumatic cylinder 44 is actuated to rotate the camshaft 22 in a first direction, for example clockwise, to urge the cam rollers 34 outwardly as a result of the outwardly extending cam surfaces moving thereagainst to thereby push the expansion plates 36 outwardly such that the contact members 38 firmly engage the cylindrical interior surface of the core. The expandable core chuck 10 may be removed from the core by actuating the pneumatic cylinder 44 to rotate the camshaft 22 in the opposite direction, for example, counterclockwise, to move the reduced sized portions of the cam surfaces relative to the cam rollers so that the springs of the expansion plates return them to a position within the housing or outer shell 12.

This invention has been described in considerable detail with reference to its preferred embodiments. However, as indicated previously, the invention is susceptible to numerous modifications, variations, and substitutions without departure from the spirit and scope of the invention as described in the foregoing detailed description and as defined in the following appended claims.

We claim:

1. An expandable chuck comprising:
(a) a cylindrical housing extending along an axis,
(b) a plurality of expansion plates in the housing each supported on support structure and movable radially from a retracted position within the housing to an expanded position extending outwardly of the housing;
(c) a camshaft in the housing extending along the axis and rotatable thereabout in a first direction and a second direction;
(d) cam surfaces on the camshaft extending radially outwardly from the axis at varying distances therefrom;
(e) each support structure including cam followers which are engaged with the cam surfaces wherein movement of the cam surfaces relative to the cam followers in the first direction moving the cam followers and the expansion plates from a retracted position to an expanded position further from the axis outwardly of the housing and movement of the cam surfaces relative to the cam followers in said second direction permitting movement of the expansion plates toward the retracted position closer to the axis; and
(f) means for rotating the camshaft in the first direction and the second direction.

2. An expansion chuck according to claim 1 wherein the housing has a plurality of slots extending parallel to the axis sized to receive therethrough the expansion plates and wherein rotation of the camshaft in the first direction moves each of the expansion plates through one of the slots.

3. An expansion chuck according to claim 1 wherein the means for rotating the camshaft is a pneumatic motor.

4. An expansion chuck according to claim 1 wherein the means for rotating the camshaft is an electric motor.

5. An expansion chuck according to claim 1 further including an elastic member for urging the expansion plates back to a retracted position upon rotation of the camshaft in said second direction.
